(19) United States
(12) Patent Application Publication
(10) Pub. No.: US 2025/0373395 A1
(43) Pub. Date: Dec. 4, 2025

(54) RADIO RESOURCE CONTROL SIGNALING FOR RELEASE 15 TRANSMISSION CONFIGURATION INDICATION BASED LOWER-LAYER TRIGGERED MOBILITY

(71) Applicant: QUALCOMM Incorporated, San Diego, CA (US)

(72) Inventors: Mohamed Atef Abdelazim SHEHATA, Lannion (FR); Jelena DAMNJANOVIC, Del Mar, CA (US); Tao LUO, San Diego, CA (US)

(21) Appl. No.: 18/680,821

(22) Filed: May 31, 2024

(51) Int. Cl. H04L 5/00; H04W 72/231

(52) U.S. Cl. CPC H04L 5/0053; H04W 72/231

(57) ABSTRACT

A network entity receives, from a user equipment, a message indicative of a type of transmission configuration indication (TCI) framework supported by the user equipment. The network entity transmits, to the user equipment, a radio resource control (RRC) configuration message, including one of one or more TCI configurations corresponding to one of one or more types of TCI frameworks supported by the network entity and supported by the user equipment as indicated in the message received from the user equipment. The message indicative of the type of TCI framework may be a user equipment capability information message. The RRC configuration message may include a lower layer triggered mobility (LTM) candidate to add modification list information element (IE) indicative of the type of TCI framework. The LTM candidate to add modification list IE may be configured as one pair of three pairs of fields.

### TECHNICAL FIELD

This disclosure relates generally to wireless communication, and more specifically, to radio resource control (RRC) signaling for Release 15 transmission configuration indication (TCI) based lower-layer triggered mobility (LTM).

### INTRODUCTION

In 5G, 6G, and future versions of wireless communication systems, certain information, such as transmission configuration information (TCI), may be used to optimize transmission configurations for improved signal quality and coverage and may be used to enhance downlink beamforming. TCI may be transmitted from a base station to a user equipment and may be used by the user equipment to configure parameters for the downlink communications. However, research is ongoing, and proposals may expand TCI so that it may help optimize both downlink and uplink communications. The 3GPP specifications may standardize TCI, but scientists and engineers are always searching for advancements and developing changes to standardized parameters to improve performance between network entities and the user equipment they serve.

### BRIEF SUMMARY OF SOME EXAMPLES

The systems, methods, and devices of this disclosure each have several innovative aspects, no single one of which is solely responsible for the desirable attributes disclosed herein.

In one example, a method is described. The method, at a network entity, includes receiving, from a user equipment, a message indicative of a type of transmission configuration indication (TCI) framework supported by the user equipment, and transmitting, to the user equipment, a radio resource control (RRC) configuration message, including one of one or more TCI configurations corresponding to one of one or more types of TCI frameworks supported by the network entity and supported by the user equipment as indicated in the message received from the user equipment.

In another example, a network entity is described. The network entity includes one or more memories and one or more processors. In the example, the one or more processors are configured to, individually or collectively, based at least in part on information stored in the one or more memories: receive, from a user equipment, a message indicative of a type of transmission configuration indication (TCI) framework supported by the user equipment, and transmit, to the user equipment, a radio resource control (RRC) configuration message, including one of one or more TCI configurations corresponding to one of one or more types of TCI frameworks supported by the network entity and supported by the user equipment as indicated in the message received from the user equipment.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic illustration of an example of a wireless communication system according to some aspects of the disclosure.

FIG. 2 is a schematic illustration of an example of a radio access network according to some aspects of the disclosure.

FIG. 3 is a schematic illustration of an example of a disaggregated base station architecture according to some aspects of the disclosure.

FIG. 4 is an expanded view of an exemplary subframe, showing an orthogonal frequency division multiplexing (OFDM) resource grid according to some aspects of the disclosure.

FIG. 5 is a schematic depiction of a 5G user plane protocol stack and a 5G control plane protocol stack according to some aspects of the disclosure.

FIG. 6 is a call flow diagram illustrating communication between a network entity and a user equipment according to some aspects of the disclosure.

FIG. 7 is a block diagram illustrating an example of a hardware implementation of a network entity employing one or more processing systems according to some aspects of the disclosure.

FIG. 8 is a flow chart illustrating an example process of wireless communication at a network entity in accordance with some aspects of the disclosure.

FIG. 9 is a flow chart illustrating an example process of wireless communication at a network entity in accordance with some aspects of the disclosure.

Like reference numbers and designations in the various drawings indicate like elements.

### DETAILED DESCRIPTION

The detailed description set forth below in connection with the appended drawings is directed to some particular examples for the purpose of describing innovative aspects of this disclosure. However, a person having ordinary skill in the art will readily recognize that the teachings herein can be applied in a multitude of different ways. Some or all of the described examples may be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system, or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple input multiple output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to persons having ordinary skill in the art that these concepts may be practiced without these specific details. In some examples, well-known structures and components are shown in block diagram form in order to avoid obscuring such concepts.

While aspects and examples are described in this application by illustration to some examples, persons having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein is a TCI framework that supports both an existing Release 15 TCI configuration as well as one or more other optional TCI configurations, such as the Unified TCI configuration. A network entity (e.g., an apparatus, an aggregated or disaggregated base station, a gNB, an eNB, a TRP, a scheduling entity, etc.) may evaluate a response to a UE capability enquiry, and by recognizing the common TCI framework(s) that are supported by the UE and the network entity, the network entity may be able to configure the UE to utilize a TCI configuration that provides an advancement over the Release 15 TCI configuration. For example, if both the network entity and the UE support the Unified TCI configuration, then the network entity may configure the UE to utilize the Unified TCI configuration (which is understood to be an advancement over the Release 15 TCI configuration). Of course, if the network entity only supports Release 15 TCI, then, even if the UE supports Unified TCI, the network entity will configure the UE to utilize a Release 15 TCI configuration.

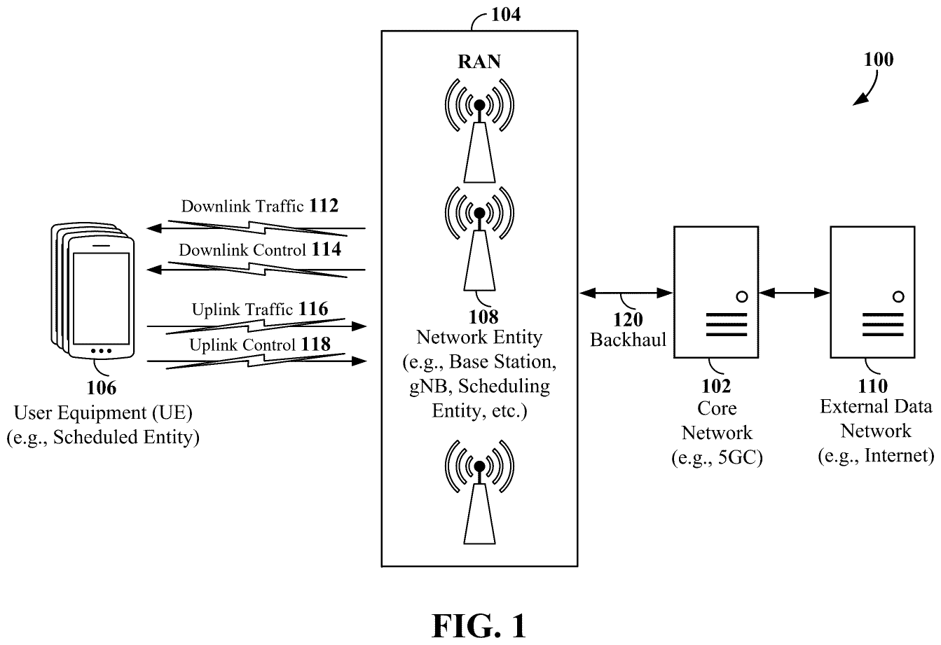

The various concepts presented throughout this disclosure may be implemented across a broad variety of telecommunication systems, network architectures, and communication standards. Referring now to FIG. 1, as an illustrative example without limitation, a schematic illustration of an example of a wireless communication system 100 according to some aspects of the disclosure is presented. The wireless communication system 100 includes three interacting domains: a core network 102, a radio access network (RAN) 104, and a user equipment (UE) 106 (e.g., of a plurality of UEs). By virtue of the wireless communication system 100, the UE 106 (also referred to herein as a wireless communication device or an apparatus) may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities 108. Broadly, a network entity may be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some examples, a network entity may be a network element in a radio access network responsible for radio transmission and reception in one or more cells to or from a UE. In different technologies, standards, or contexts, a network entity may variously be referred to by persons having ordinary skill in the art as a base transceiver station (BTS), a radio base station, a base station, a radio transceiver, a transceiver function, a basic service set (BSS), an extended service set (ESS), an access point (AP), a Node B (NB), an eNode B (eNB), a gNode B (gNB), a transmission and reception point (TRP), a scheduling entity, a network access point, or some other suitable terminology. In some examples, a network entity 108 may include two or more TRPs that may be collocated or non-collocated. Each TRP may communicate on the same or different carrier frequency within the same or different frequency band. In examples where the RAN 104 operates according to both the LTE and 5G NR standards, one of the network entities may be an LTE network entity, while another network entity may be a 5G NR network entity.

The RAN 104 is further illustrated supporting wireless communication for multiple mobile apparatuses, one of which may be identified as UE 106. A mobile apparatus may be referred to as user equipment (UE) in 3GPP standards, but may also be referred to by persons having ordinary skill in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, a scheduled entity, or some other suitable terminology. The UE 106 may be an apparatus (e.g., a mobile apparatus, a wireless communication device) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smartphone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus (e.g., UE 106) may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smartwatch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data and/or relevant QoS for transport of critical service data.

Wireless communication between the RAN 104 and the UE 106 may be described as utilizing an air interface. Transmissions over the air interface from a network entity (e.g., similar to network entity 108) to one or more UEs (e.g., similar to UE 106) may be referred to as downlink (DL) transmission. In accordance with certain aspects of the present disclosure, the term downlink may refer to a point-to-multipoint transmission or a point-to-point transmission (e.g., groupcast, multicast, or unicast) originating at a network entity (e.g., network entity 108). Another way to describe this scheme may be to use the term broadcast channel multiplexing. Transmissions from a UE (e.g., UE 106) to a network entity (e.g., network entity 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, where a network entity (e.g., a network entity 108) allocates resources for communication among some or all devices and equipment within its service area or cell. Within the present disclosure, as discussed further below, the network entity (e.g., network entity 108) may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the network entity 108.

Network entities 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, the network entity 108 may broadcast downlink traffic 112 (also referred to as downlink data traffic) to one or more UEs 106. Broadly, the network entity 108 may be a node or device responsible for scheduling traffic (e.g., data traffic, user data traffic) in a wireless communication network, including the downlink traffic 112 and, in some examples, uplink traffic 116 (also referred to as uplink data traffic) from one or more UEs 106 to the network entity 108. On the other hand, the UE 106 (e.g., the scheduled entity) may be a node or device that receives downlink control 114 information, including but not limited to scheduling information (e.g., a grant), synchronization or timing information, or other control information from another entity in the wireless communication network such as the network entity 108. The UE 106 may further transmit uplink control 118 information, including but not limited to a scheduling request or feedback information, or other control information to the network entity 108.

In addition, the uplink control 118 information and/or downlink control 114 information and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, the network entity 108 may include a backhaul interface (not shown) for communication with a backhaul portion 120 of the wireless communication system 100. The backhaul portion 120 may provide a link between a network entity 108 and the core network 102. Further, in some examples, a backhaul network may provide interconnection between respective network entities 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC) or any other suitable standard or configuration.

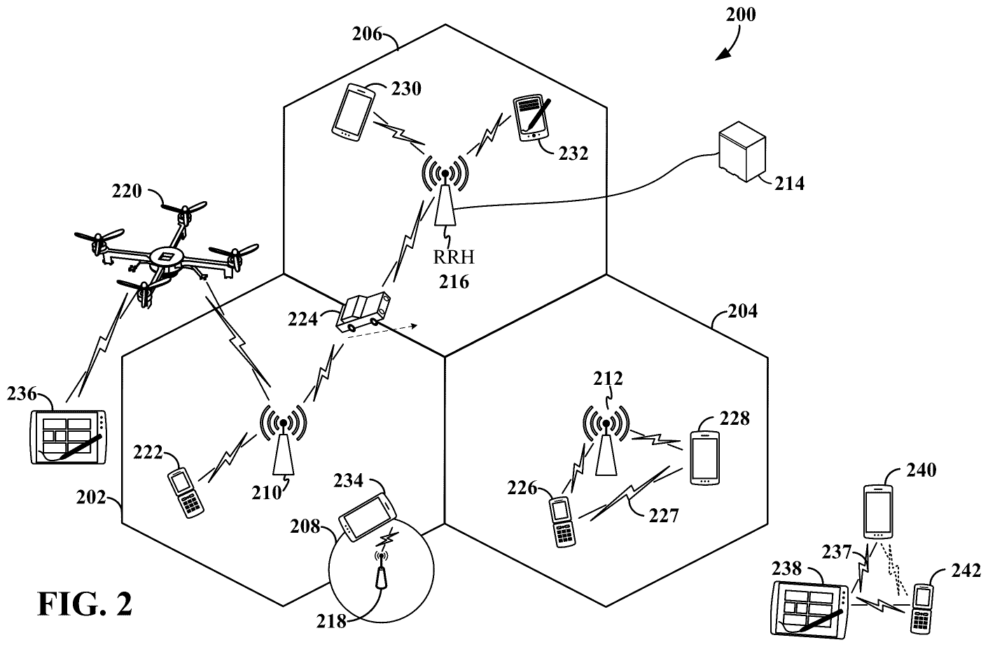

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or network entity. FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas, with each antenna responsible for communication with UEs in a portion of the cell.

Various network entity arrangements can be utilized. For example, in FIG. 2, two network entities, referred to as base station 210 and base station 212, are shown in cells 202 and 204. A third network entity, referred to as base station 214, is shown controlling a remote radio head (RRH) 216 in cell 206. That is, a network entity can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of network entities (e.g., base stations, gNBs, TRPs, scheduling entities) and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the network entity 108 described above and illustrated in FIG. 1.

FIG. 2 further includes an unmanned aerial vehicle (UAV) 220, which may be a drone, quadcopter, octocopter, etc. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, and/or 242 may be the same as or similar to the one or more UEs 106 described above and illustrated in FIG. 1. In some examples, the UAV 220 may be a mobile network entity and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station (e.g., a network entity). In other examples, two or more UEs (e.g., UEs 226 and 228) within the coverage area of a network entity (e.g., base station 212) may also communicate sidelink signals 227 over a direct link (sidelink) without conveying that communication through the network entity (e.g., base station 212). In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. The exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of network entities and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a network entity (e.g., an apparatus, an aggregated or disaggregated base station, a gNB, an eNB, a TRP, a scheduling entity, etc.), or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if the signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell (e.g., cell 202) to the geographic area corresponding to a neighbor cell (e.g., cell 206). When the signal strength or quality from the neighbor cell exceeds that of its serving cell for a given amount of time, the UE 224 may transmit a reporting message to its serving network entity (e.g., base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast Unified synchronization signals (e.g., Unified Primary Synchronization Signals (PSSs), Unified Secondary Synchronization Signals (SSSs) and Unified Physical Broadcast Channels (PBCHs)). The UEs 222, 224, 226, 228, 230, and 232 may receive the Unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be Unified, the synchronization signal may not identify a particular cell, but rather may identify a zone of multiple cells operating on the same frequency and/or with the same timing. The use of zones in 5G networks or other next generation communication networks enable the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, where technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic is spectrum often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different subbands of the carrier bandwidth. This type of full-duplex communication may be referred to herein as subband full-duplex (SBFD), also known as flexible duplex.

Deployment of communication systems, such as 5G new radio (NR) systems, may be arranged in multiple manners with various components or constituent parts. In a 5G NR system, or network, a network entity, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (eNB), gNB, NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

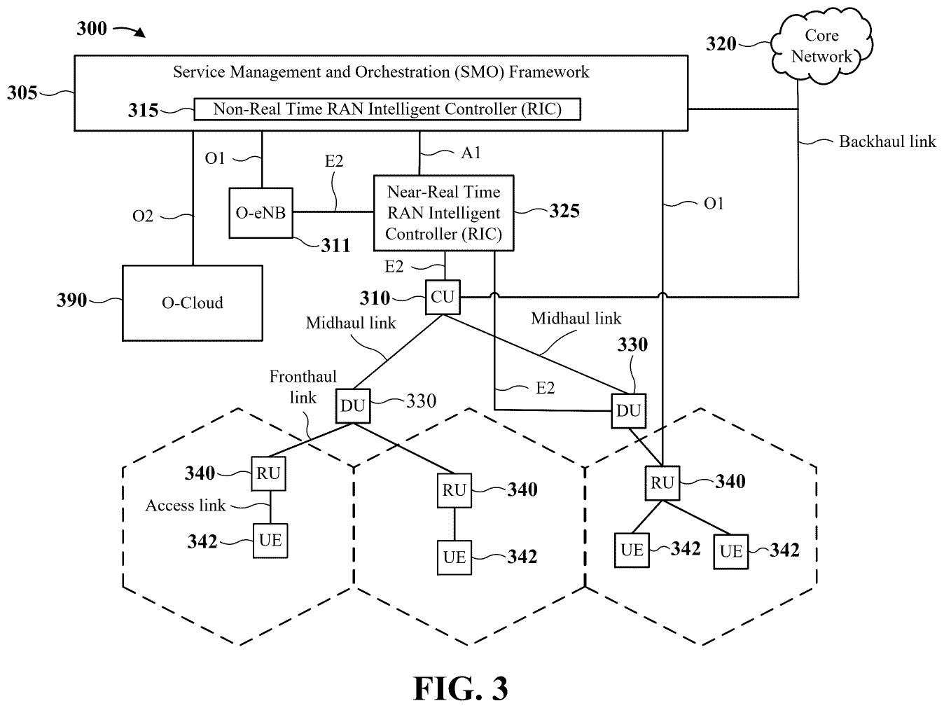

FIG. 3 is a schematic illustration of an example disaggregated base station 300 architecture according to some aspects of the disclosure. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 342 via one or more radio frequency (RF) access links. In some implementations, the UE 342 may be simultaneously served by multiple RUs 340. UE 342 may be the same or similar to any of the UEs or scheduled entities illustrated and described in connection with FIG. 1 and FIG. 2, for example.

Each of the units, i.e., the CUS 310, the DUs 330, the RUs 340, as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 342. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 3G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

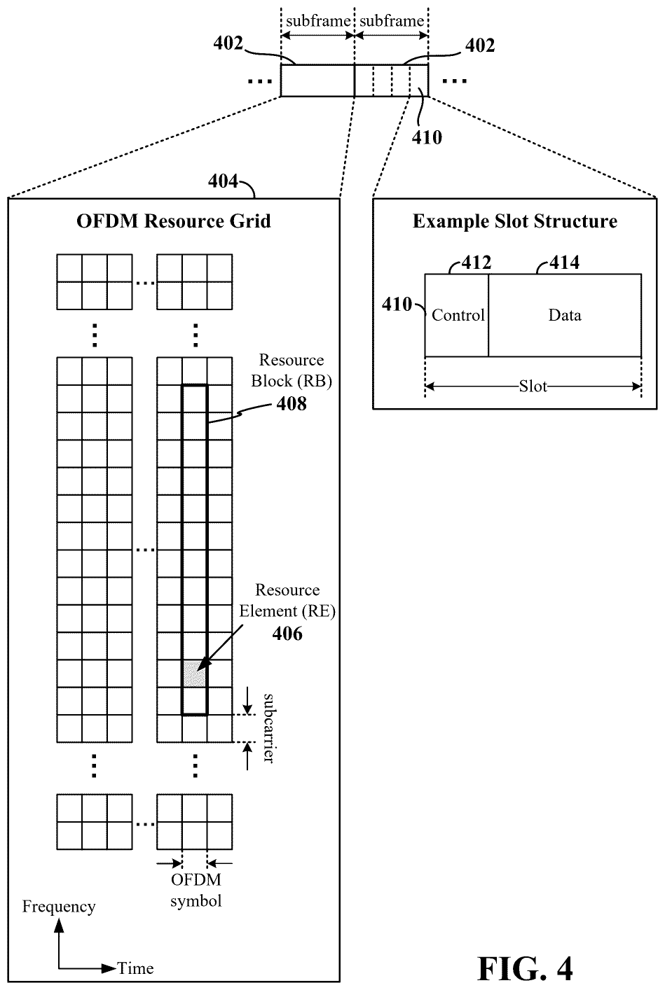

Various aspects of the present disclosure will be described with reference to an OFDM waveform, schematically illustrated in FIG. 4. It should be understood by persons having ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, as persons having ordinary skill in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple input multiple output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), subband, or bandwidth part (BWP). A set of subbands or BWPs may span the entire bandwidth. Scheduling of wireless communication devices (e.g., V2X devices, sidelink devices, or other UEs, hereinafter generally referred to as UEs) for downlink, uplink, or sidelink transmissions may involve scheduling one or more resource elements 406 within one or more subbands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., an aggregated or disaggregated base station, gNB, eNB, TRP, scheduling entity, etc.) or may be self-scheduled by a UE/sidelink device implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. An additional example may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of slot 410 illustrates that the slot 410 includes a control region 412 and a data region 414. In general, the control region 412 may carry control channels, and the data region 414 may carry data channels. In some examples, a Uu slot (e.g., slot 410) may contain all DL, all UL, or at least one DL portion and at least one UL portion. The structures illustrated in FIG. 4 are merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the network entity may allocate one or more REs 406 (e.g., within the control region 412) of the slot 410 to carry DL control information including one or more DL control channels, such as a physical downlink control channel (PDCCH), to one or more UEs (e.g., scheduled entities). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to persons having ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) of the Uu slot 410 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 4, 10, 20, 50, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (MSI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the UE (e.g., scheduled entity) may utilize one or more REs 406 of the Uu slot 410 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. In response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 406 (e.g., within the data region 414) of the Uu slot 410 may be allocated for data traffic. Such data traffic may be carried on one or more traffic channels, such as, for a DL transmission, a physical downlink shared channel (PDSCH); or for a UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB 1, discussed above. For example, the OSI may be provided in these SIBs, e.g., SIB2 and above.

In an example of sidelink communication over a sidelink carrier via a PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, sidelink MAC-CEs may be transmitted in the data region 414 of the slot 410. In addition, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

The physical channels described above are generally multiplexed and mapped to transport channels for handling at the medium access control (MAC) layer. Transport channels carry blocks of information called transport blocks (TB). The transport block size (TBS), which may correspond to a number (e.g., a quantity) of bits of information, may be a controlled parameter based on the modulation and coding scheme (MCS) and the number of RBs in a given transmission.

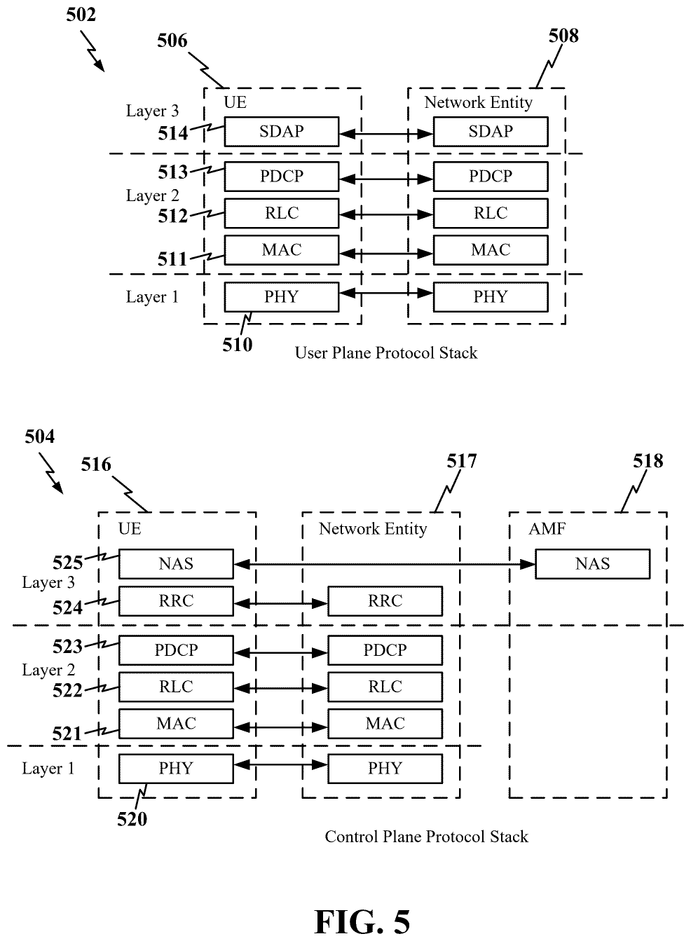

FIG. 5 is a schematic depiction of a 5G user plane protocol stack 502 and a 5G control plane protocol stack 504 according to some aspects of the disclosure. The user plane protocol stack 502 depicts a first protocol stack 506 of a UE and a second protocol stack 508 of a network entity (e.g., an apparatus, an aggregated or disaggregated base station, a gNB, an eNB, a TRP, a scheduling entity, etc.). The first and second protocol stacks include the following layers: physical (PHY) 510, medium access control (MAC) 511, radio link control (RLC) 512, packet data convergence protocol (PDCP) 513, and service data adaptation protocol (SDAP) 514. The functions of each of the layers are well known and will not be presented herein for the sake of brevity. With reference to layers of a numbered layer protocol stack model, the PHY 510 layer may occupy Layer 1 (L1), the MAC 511, RLC 512, and PDCP 513 layers may occupy Layer 2 (L2), and the SDAP 514 layer may occupy Layer 3 (L3).

The control plane protocol stack 504 depicts a third protocol stack 516 of the UE, a fourth protocol stack 517 of the network entity, and a fifth protocol stack 518 of an access and mobility management function (AMF). The third protocol stack 516 of the UE and the fourth protocol stack 517 of the network entity include the following layers: PHY 520, MAC 521, RLC 522, PDCP 523, and radio resource control (RRC) 524. The third protocol stack 516 of the UE and the fifth protocol stack 518 of the AMF include a non-access stratum (NAS) 525 layer. As with the user plane protocol stack 502, the functions of each of the layers of the control plane protocol stack 504 are well-known and will not be presented herein for the sake of brevity. With reference to layers of a numbered layer protocol stack model, the PHY 520 layer may occupy Layer 1 (L1), and the MAC 521, RLC 522, and PDCP 523 layers may occupy Layer 2 (L2). The NAS 525 layer may occupy Layer 3 (L3). According to some aspects, the terms lower-layer triggered mobility (LTM) and L1/L2 triggered mobility may be synonymous.

The channels, carriers, and layers of protocol stacks described above in connection with FIGS. 1-5 are not necessarily all of the channels, carriers, and layers of protocol stacks that may be utilized between devices, and persons of ordinary skill in the art will recognize that other channels or carriers (such as other traffic, control, and feedback channels) or layers of protocol stacks may be utilized in addition to those illustrated.

New features are continually proposed in connection with 5G New Radio (NR) and the 3GPP standards for wireless communication in general. The proposals include those directed to user equipment (UE) lower-layer triggered mobility (LTM) antenna beam indication with joint downlink/uplink (DL/UL) transmission configuration indication (TCI) states. This proposed LTM feature may be coupled to a “Unified TCI” configuration, which may be an improvement over, or at least is different from, a “Release 15 TCI” configuration.

In some examples, the Unified TCI configuration may incorporate an RRC message (e.g., from a network entity to a UE) that includes a list of downlink TCI states and joint TCI states (where joint TCI states refers to joint downlink and uplink TCI states) and a separate list of uplink TCI states. While not currently contemplated for Release 18, nothing herein is meant to limit the Unified TCI configuration to a list of downlink TCI states and joint TCI states and a separate list of uplink TCI states. Consequently, the scope of this disclosure includes the just-recited Unified TCI configuration, and also includes otherwise named TCI configurations that may include, for example, a group of individual lists of downlink, joint, and uplink TCI states, a single list of downlink, joint, and uplink TCI states, or a group of lists that includes a list of downlink TCI states and a separate list of joint and uplink TCI states. In contrast, the Release 15 TCI configuration includes an RRC message with a list of downlink TCI states.

According to some aspects, the LTM feature may be tightly coupled to the Unified TCI feature and an L1 measurement feature for inter 1 intra frequency. If the proposed LTM feature (or a similar feature) is a requirement for Release 18, and if a UE does not support the proposed LTM feature (or the similar feature), then the UE cannot be characterized as being compliant with Release 18. Therefore, a rigid Release 18 requirement mandating UEs to support the LTM feature may preclude many UE from being identified as Release 18 compliant devices. To avoid this outcome there is proposed herein an option in which a UE can employ the LTM feature independently or employ optionally the LTM feature (i.e., the Unified TCI configuration) or the Release 15 TCI configuration. Therefore, if Release 18 permits either the option, even if the UE does not support LTM beam indication with joint downlink and uplink TCI states, the UE would still support a list of downlink TCI states (i.e., as in Release 15) and therefor be compliant with Release 18 of the 3GPP NR standards. In other words, incorporation of the option for Release 18 allows the LTM feature to work independently or optionally coupled with other features (making such an adopted Release 18 more flexible). In other words, when using the more flexible option, a UE may not support beam indication with joint downlink and uplink LTM TCI states, but nevertheless will still support the legacy Release 15 TCI configuration.

A mandate to support Unified TCI as an obligatory UE capability (in order for a UE to support the Release 18 LTM feature) is unduly restrictive in at least the following scenarios: 1) the UE is not capable of supporting Unified TCI (i.e., the UE only supports Release 15 TCI); and 2) the UE is capable of supporting Unified TCI but the network entity serving the UE is not capable of supporting Unified TCI. to overcome this undue restriction, described herein is a framework to support a Release 15 TCI exception to Unified TCI for support of LTM.

Table 1, below, may be referred to as a decision table that may be used by a network entity to determine whether to transmit an RRC configuration message with a Unified TCI configuration (e.g., a list of downlink and joint TCI states and a separate list of uplink TCI states) or a Release 15 TCI configuration (e.g., a list of downlink TCI states).

TABLE I
Decision Table

| UE Capability | | Network Entity Capability | | |
|---|---|---|---|---|
| Supports | Only Supports | Supports | Only Supports | |
| Unified TCI | Release 15 | Unified TCI | Release 15 | |
| with LTM | TCI with LTM | with LTM | TCI with LTM | Network Entity Decision |
| True | | True | | RRC config with Unified TCI list |
| True | | | True | RRC config with Rel15 TCI list |
| | True | True | | RRC config with Rel15 TCI list |
| | True | | True | RRC config with Rel15 TCI list |

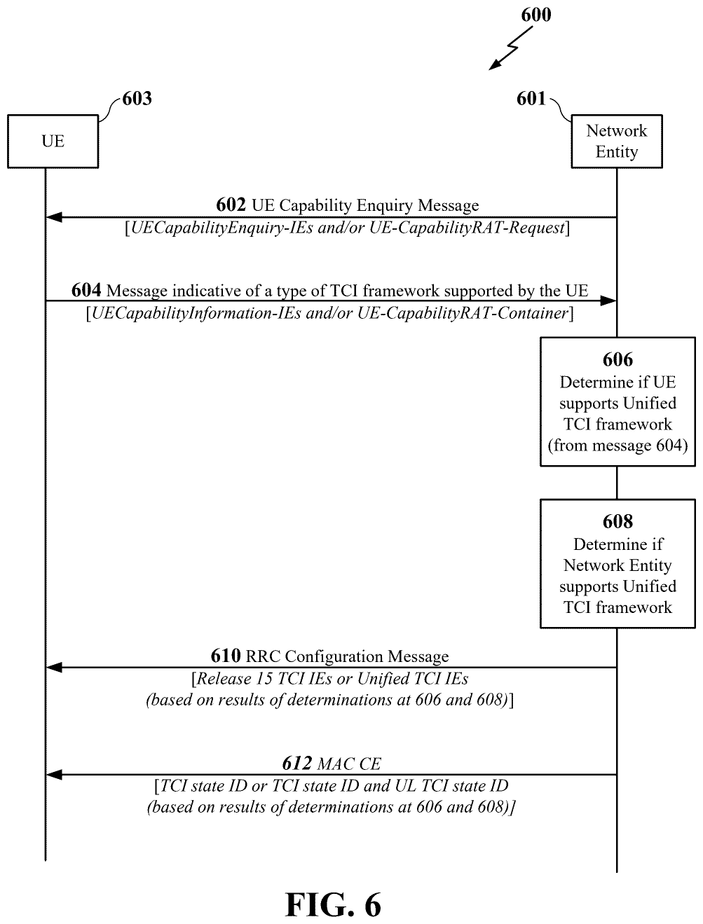

FIG. 6 is a call flow diagram 600 illustrating communication (e.g., an exchange of messages related to TCI) between a network entity 601 (e.g., an apparatus, an aggregated or disaggregated base station, a gNB, an eNB, a TRP, a scheduling entity, etc.) and a user equipment (UE) 603 according to some aspects of the disclosure. The UE 603 may be any user equipment or scheduled entity as shown and described, for example, in connection with FIGS. 1, 2, 3, and/or 5. The network entity 601 (an apparatus) may be any aggregated or disaggregated base station, gNB, eNB, TRP, or scheduling entity as shown and described, for example, in connection with FIGS. 1, 2, 3, and/or 5. In some examples, the network entity 601 may be implemented as an aggregated base station or a disaggregated base station. In a disaggregated base station architecture, the network entity 601 may include one or more of a central unit (CU), a distributed unit (DU), or a radio unit (RU).

At 602, the network entity 601 may transmit a UE capability enquiry (also known as an inquiry) to the UE 603. The UE capability enquiry may be a UECapabilityEnquiry Message, which may include UE Capability Enquiry information elements (UECapabilityEnquiry-IEs) and/or a UECapabilityRAT-RequestList, for example.

At 604, in response to receiving the UE capability enquiry, the UE 603 may transmit to the network entity 601 (and the network entity 601 may receive from the UE 603) UE capability information. The UE capability information may be included in a message. The message may be indicative of a type of transmission configuration indication (TCI) framework supported by the user equipment. For example, the UE 603 may support Release 15 TCI with LTM, or support Unified TCI with LTM, or support both Release 15 TCI with LTM and Unified TCI with LTM. In some examples, the message may be or may include a user equipment features list. The user equipment features list may include one of a first feature corresponding to LTM beam indication with joint downlink and uplink TCI states indicative of an optional Unified TCI framework, or a second feature corresponding to LTM beam indication with DL TCI states indicative of a Release 15 TCI framework.

At 606, in response to receiving the UE capability information (e.g., in the message) from the UE 603, the network entity 601 may determine (e.g., based on the UE capability information received from the UE 603) whether the UE 603 supports Release 15 TCI with LTM, or supports Unified TCI with LTM, or supports both Release 15 TCI with LTM and Unified TCI with LTM. For example, at 606, the network entity 601 may determine if the UE 603 supports the Unified TCI framework (or if the UE 603 only supports the Release 15 TCI framework).

At 608, the network entity 601 may determine whether it (i.e., the network entity 601 itself) supports Release 15 TCI with LTM, or supports Unified TCI with LTM, or supports both Release 15 TCI with LTM and Unified TCI with LTM. For example, if the network entity 601 only supports Release 15 TCI with LTM, then even if the UE supports Unified TCI with LTM, the network entity 601 could not configure the UE to with Unified TCI with LTM; the network entity 601 could only configure the UE 603 with Release 15 TCI with LTM. In connection with the determination at 608, the network entity 601 may refer to a logic table, such as Table I above, to decide how to configure the UE 603. Of course, the logic table, such as Table I, is only an example, and other ways for the network entity 601 to determine how to configure the UE 603 are within the scope of the disclosure.

Based at least on the result of the determination at 606 and the determination at 608, the network entity may compile the RRC configuration message to configure the UE 603 with either a list of downlink TCI states in accordance with a Release 15 TCI configuration, or a first list of downlink TCI states and joint TCI states and a second list of uplink TCI states in accordance with a Unified TCI configuration.

At 610, the network entity may transmit, to the user equipment, the radio resource control (RRC) configuration message, including one of one or more TCI configurations corresponding to one of one or more types of TCI frameworks supported by the network entity and supported by the user equipment as indicated in the message received from the user equipment. For example, if the UE 603 does not support Unified TCI configurations (i.e., the UE only supports Release 15 TCI configurations) and the network entity supports both Release 15 TCI configurations and Unified TCI configurations, the network entity 601 may transmit a radio resource control (RRC) configuration message, including a Release 15 TCI configuration to the user equipment. Still, if the UE 603 does support Unified TCI configurations and the network entity supports both Release 15 TCI configurations and Unified TCI configurations, the network entity 601 may transmit a radio resource control (RRC) configuration message, including a Unified TCI configuration to the user equipment. Still further, if the UE 603 does support Unified TCI configurations (and also supports Release 15 TCI configurations) and the network entity only supports Release 15 TCI configurations, the network entity 601 may transmit a radio resource control (RRC) configuration message, including a Release 15 TCI configuration to the user equipment.

At 612, the network entity 601 may transmit, to the UE 603, a medium access control-control element (MAC-CE), including: a TCI state identifier (TCI state ID) and an uplink TCI state identifier (UL TCI state ID), in response to the network entity and the user equipment supporting the type of TCI framework corresponding to the Unified TCI framework, or the TCI state ID in an absence of the UL TCI state ID, in response to the network entity, the user equipment, or both the network entity and the user equipment supporting the type of TCI framework corresponding to other than the Unified TCI framework.

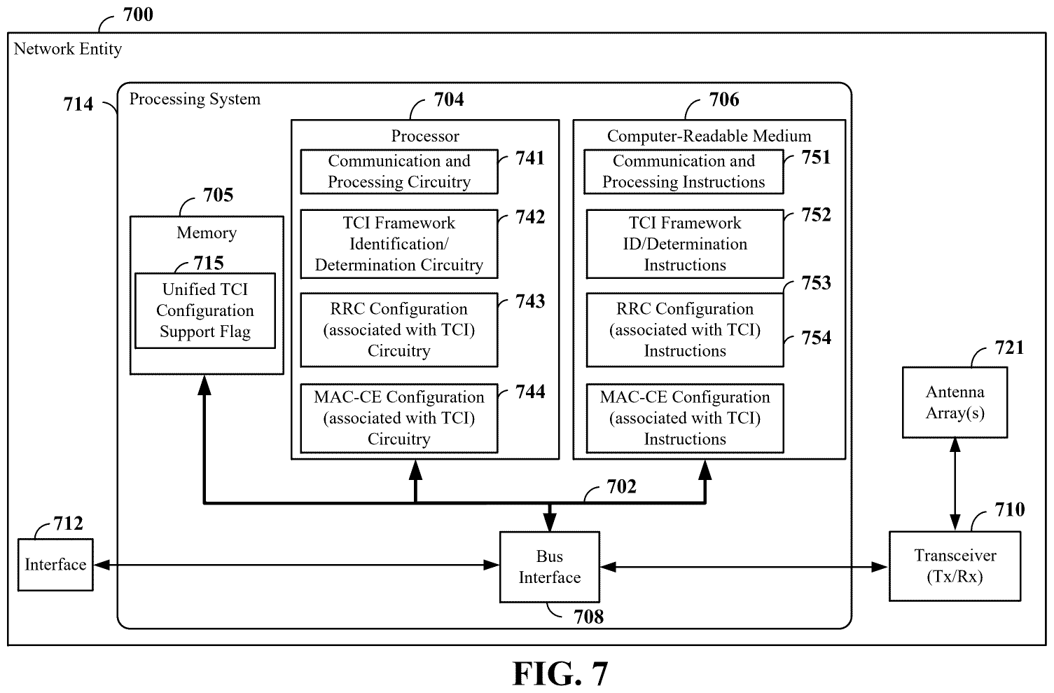

FIG. 7 is a block diagram illustrating an example of a hardware implementation of a network entity 700 (e.g., an apparatus, an aggregated or disaggregated base station, a gNB, an eNB, a TRP, a scheduling entity, etc.) employing one or more processing systems (generally represented by processing system 714) according to some aspects of the disclosure. The network entity 700 may be similar to, for example, any of the network entities or scheduling entities of FIGS. 1, 2, 3, 5, and/or 6.

In accordance with various aspects of the disclosure, an element, any portion of an element, or any combination of elements may be implemented with a processing system 714 that includes one or more processors, generally represented by processor 704, and one or more memories, generally represented by the memory 705 and additionally or alternatively generally represented by the computer-readable medium 706. Examples of processor 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 700 may be configured to perform any one or more of the functions described herein. That is, the one or more processors (generally represented by processor 704), as utilized in the network entity 700, may be configured to, individually or collectively, based at least in part on information stored in the one or more memories (generally represented by the memory 705 and additionally or alternatively generally represented by the computer-readable medium 706), implement (e.g., perform) any one or more of the methods or processes described and illustrated, for example, in FIGS. 1, 2, 3, 5, and/or 6.

In this example, the processing system 714 may be implemented with a bus architecture, represented generally by the bus 702. The bus 702 may include any number of interconnecting buses and bridges depending on the specific application of the processing system 714 and the overall design constraints. The bus 702 communicatively couples together various circuits, including one or more processors (generally represented by the processor 704), one or more memories (generally represented by the memory 705), and one or more computer-readable media (generally represented by the computer-readable medium 706). The bus 702 may also link various other circuits such as timing sources, peripherals, voltage regulators, and power management circuits, which are well known to persons having ordinary skill in the art and, therefore, will not be described any further.

A bus interface 708 provides an interface between the bus 702 and a transceiver 710. The transceiver 710 may be, for example, a wireless transceiver. The transceiver 710 may be operational with multiple RATs (e.g., LTE, 5G NR, IEEE 802.11 (WiFi®), etc.). The transceiver 710 may provide respective means for communicating with various other apparatus, UEs, network entities, and core networks over a transmission medium (e.g., air interface). The transceiver 710 may be coupled to one or more respective antenna array(s) 721. The bus interface 708 may provide an interface between the bus 702 and a user interface 712 (e.g., keypad, display, touch screen, speaker, microphone, control features, vibration circuit/device, etc.). Of course, such a user interface 712 is optional and may be omitted in some examples.

One or more processors, represented individually and collectively by processor 704, may be responsible for managing the bus 702 and general processing, including the execution of software stored on the computer-readable medium 706. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 706. The software, when executed by the processor 704, causes the processing system 714 to perform the various processes and functions described herein for any particular apparatus.

The computer-readable medium 706 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., one or more processors) to implement one or more of the functions described herein (e.g., in connection with FIG. 6). A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities, including the processing system 714. The computer-readable medium 706 may be embodied in a computer program product or article of manufacture. For example, a computer program product or article of manufacture may include a computer-readable medium in packaging materials. In some examples, the computer-readable medium 706 may be part of the memory 705. Persons having ordinary skill in the art will recognize how best to implement the described functionality presented throughout this disclosure depending on the particular application and the overall design constraints imposed on the overall system. The computer-readable medium 706 and/or the memory 705 may also be used for storing data that is manipulated by the processor 704 when executing software.

In some aspects of the disclosure, the processor 704 may include communication and processing circuitry 741 configured for various functions, including, for example, communicating with a user equipment (UE) (e.g., an apparatus, a wireless device, a mobile device, a scheduled entity) and/or a core network. In some examples, the communication and processing circuitry 741 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 741 may be configured to determine if a UE, responding to a request for UE capability information transmitted from the network entity 700, supports a Unified TCI framework. The determination may be based, for example, on analysis of a response to a request (sent to a UE) for UE capability information. In some examples, the communication and processing circuitry 741 may be further configured to receive, at the network entity 700, a message indicative of the type of TCI framework in response to transmitting, to the user equipment, a user equipment capability enquiry message. In another example, the communication and processing circuitry 741 may be configured to determine if the network entity 700 itself supports a Unified TCI framework. For example, a Unified TCI configuration support flag 715, stored in the memory 705, may be set to indicate that the network entity 700 supports the Unified TCI configuration framework (or set to indicate that the network entity 700 does not support the Unified TCI configuration framework, or set to indicate that the network entity 700 supports a Release 15 TCI configuration framework). The communication and processing circuitry 741 may further be configured to execute communication and processing instructions 751 (e.g., software) stored, for example, on the computer-readable medium 706 to implement one or more functions described herein.

In some aspects of the disclosure, the processor 704 may include TCI framework identification or determination circuitry 742 that may include one or more hardware components that provide the physical structure that performs processes related to various functions, including, for example, receiving, from a user equipment (e.g., any user equipment or scheduled entity as shown and described in connection with FIGS. 1, 2, 3, 5, and/or 6), a message indicative of a type of transmission configuration indication (TCI) framework supported by the user equipment. In some examples, the message indicative of the type of TCI framework may be a user equipment capability information (UECapabilityInformation) message. The message may indicate that the user equipment supports a Release 15 TCI framework in some examples. The message may indicate that the user equipment supports a Unified TCI framework in some examples. The message may indicate that the user equipment supports both the Release 15 TCI framework and the Unified TCI framework in some examples. The TCI framework identification or determination circuitry 742 may further be configured to execute TCI framework identification or determination instructions 752 (e.g., software) stored, for example, on the computer-readable medium 706 to implement one or more functions described herein.

In some aspects of the disclosure, the processor 704 may include RRC configuration circuitry 743 that may include one or more hardware components that provide the physical structure that performs processes related to various functions, including, for example, a process of configuring (e.g., compiling, composing, generating) a radio resource control (RRC) configuration message (e.g., associated with TCI frameworks). For example, the RRC configuration circuitry 743 may configure the radio resource control (RRC) configuration message, including one of one or more TCI configurations corresponding to one of one or more types of TCI frameworks supported by the network entity 700 and supported by the user equipment as indicated in the message received from the user equipment. The RRC configuration circuitry 743, in association with the communication and processing circuitry 741 and/or the transceiver 710 and the antenna array(s) 721, may further be configured to transmit, to the user equipment, the radio resource control (RRC) configuration message, including the one of one or more TCI configurations corresponding to the one of one or more types of TCI frameworks supported by the network entity 700 and supported by the user equipment as indicated in the message received from the user equipment.

In some examples, the RRC Configuration circuitry 743, in association with the communication and processing circuitry 741 and/or the transceiver 710 and the antenna array(s) 721, may further be configured to transmit, to the user equipment, the RRC configuration message including a Unified TCI configuration, in response to the network entity 700 and the user equipment supporting the type of TCI framework corresponding to a Unified TCI framework. The Unified TCI configuration may include a first list of downlink TCI states and joint TCI states, and a second list of uplink TCI states.

In some examples, the RRC Configuration circuitry 743, in association with the communication and processing circuitry 741 and/or the transceiver 710 and the antenna array(s) 721, may further be configured to transmit, to the user equipment, the RRC configuration message including a Release 15 TCI configuration, in response to at least one of the network entity 700 or the user equipment supporting the type of TCI framework corresponding to other than a Unified TCI framework. The Release 15 TCI configuration may include a list of downlink TCI states.

In some examples, the RRC Configuration circuitry 743 may configure an RRC message to include a lower layer triggered mobility (LTM) candidate to add modification list information element indicative of the type of TCI framework. For example, a CandidateToAddModList information element (IE) that may contain different elements, such as Unified TCI state IEs if the UE supports a Unified TCI framework or Release 15 TCI state IEs if the UE only supports (or the network entity serving the UE only supports) a Release 15 TCI framework. In some examples, the LTM candidate to add modification list information element may be configured as one pair of three pairs of fields corresponding to: a first pair of fields indicative of LTM downlink and joint TCI states to add and LTM downlink or joint TCI states to release, a second pair of fields indicative of LTM uplink TCI states to add and LTM uplink TCI states to release, and a third pair of fields indicative of LTM downlink TCI states to add and LTM downlink TCI states to release. In some examples, the LTM downlink and joint TCI states to add field may correspond to an ltm-dl-OrJointTCI-StateToAddModList-r18 field in an LTM-TCI-Info information element. In some examples, the LTM downlink or joint TCI states to release field may correspond to an ltm-dl-OrJointTCI-StateToReleaseList-r18 field in the LTM-TCI-Info information element. In some examples, the LTM uplink TCI states to add field may correspond to an ltm-ul-TCI-ToAddModList-r18 field in the LTM-TCI-Info information element. In some examples the LTM uplink TCI states to release field may correspond to an ltm-ul-TCI-ToReleaseList-r18 field in the LTM-TCI-Info information element. In some examples, the LTM downlink TCI states to add field may correspond to an ltm-dl-TCI-ToAddModList-r18 field of the LTM-TCI-Info information element. In some examples, the LTM downlink TCI states to release field may correspond to an ltm-dl-TCI-ToReleaseList-r18 of the LTM-TCI-Info information element.

The RRC configuration circuitry 743 may further be configured to execute RRC configuration instructions 753 (e.g., software) stored, for example, on the computer-readable medium 706 to implement one or more functions described herein.

In some aspects of the disclosure, the processor 704 may include MAC-CE configuration (e.g., associated with TCI) circuitry 744 (e.g., associated with TCI) that may include one or more hardware components that provide the physical structure that performs processes related to various functions, including, for example, transmitting, to the user equipment, a medium access control-control element (MAC-CE) including: a TCI state identifier (TCI state ID) and an uplink TCI state identifier (UL TCI state ID), in response to the network entity 700 and the user equipment supporting the type of TCI framework corresponding to a Unified TCI framework, or the TCI state ID in an absence of the UL TCI state ID, in response to the network entity 700, the user equipment, or both the network entity 700 and the user equipment supporting the type of TCI framework corresponding to other than the Unified TCI framework. The MAC-CE configuration circuitry 744 may further be configured to execute MAC-CE configuration instructions 754 (e.g., software) stored on the computer-readable medium 706 to implement one or more functions described herein.

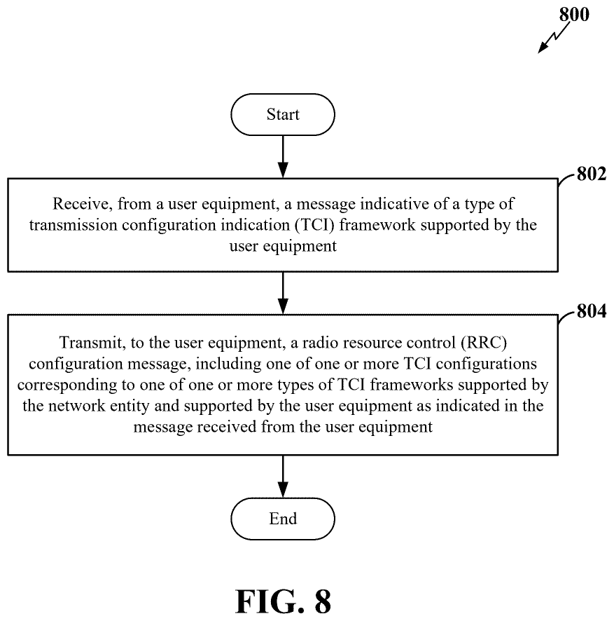

FIG. 8 is a flow chart illustrating an example process 800 (e.g., a method) of wireless communication at a network entity (e.g., an apparatus, an aggregated or disaggregated base station, a gNB, an eNB, a TRP, a scheduling entity, etc.) in accordance with some aspects of the disclosure. As described below, some or all illustrated features may be omitted in a particular implementation within the scope of the present disclosure, and some illustrated features may not be required for implementation of all embodiments. In some examples, the process 800 may be carried out by the network entity 700, as shown and described in connection with FIG. 7. The network entity 700 may be similar to, for example, any of the network entities or scheduling entities of FIGS. 1, 2, 3, 5, 6, and/or 7. In some examples, the process 800 may be carried out by any suitable apparatus or means for carrying out the functions or algorithm described below.

At block 802, the network entity may receive, from a user equipment, a message indicative of a type of transmission configuration indication (TCI) framework supported by the user equipment. For example, the message indicative of the type of TCI framework may be received at the network entity in response to transmitting (from the network entity to the user equipment) a user equipment capability enquiry message. In one aspect, the message indicative of the type of TCI framework may be a user equipment capability information (UECapabilityInformation) message. For example, the TCI framework identification or determination circuitry 742, in combination with the transceiver 710 and antenna array(s) 721, may provide a means for receiving, from a user equipment, a message indicative of a type of transmission configuration indication (TCI) framework supported by the user equipment. In one example, the message may be or may include a user equipment features list. The user equipment features list may include one of a first feature corresponding to LTM beam indication with joint downlink and uplink TCI states indicative of an optional Unified TCI framework, or a second feature corresponding to LTM beam indication with DL TCI states indicative of a Release 15 TCI framework.

At block 804, the network entity may transmit, to the user equipment, a radio resource control (RRC) configuration message, including one of one or more TCI configurations corresponding to one of one or more types of TCI frameworks supported by the network entity and supported by the user equipment as indicated in the message received from the user equipment. According to one aspect, the RRC configuration message may include a Unified TCI configuration in response to the network entity and the user equipment supporting the type of TCI framework corresponding to a Unified TCI framework. According to another aspect, the RRC configuration message may include a Release 15 TCI configuration in response to at least one of the network entity or the user equipment supporting the type of TCI framework corresponding to other than a Unified TCI framework. In one example, the Unified TCI configuration may include a first list of downlink TCI states and joint TCI states and a second list of uplink TCI states, whereas the Release 15 TCI configuration may include a list of downlink TCI states. Other contents of the Unified TCI configuration and the Release 15 TCI configuration are within the scope of the disclosure. For example, the RRC configuration circuitry 743, in combination with the transceiver 710 and antenna array(s) 721, for example, may provide a means for transmitting, to the user equipment, a radio resource control (RRC) configuration message, including one of one or more TCI configurations corresponding to one of one or more types of TCI frameworks supported by the network entity and supported by the user equipment as indicated in the message received from the user equipment.

In some examples, the RRC configuration message may include a lower layer triggered mobility (LTM) candidate to add modification list information element indicative of the type of TCI framework. According to some aspects, the LTM candidate to add modification list information element may be configured as one pair of three pairs of fields corresponding to: a first pair of fields indicative of LTM downlink and joint TCI states to add and LTM downlink or joint TCI states to release, a second pair of fields indicative of LTM uplink TCI states to add and LTM uplink TCI states to release, and a third pair of fields indicative of LTM downlink TCI states to add and LTM downlink TCI states to release. In some examples, the LTM downlink and joint TCI states to add field may correspond to an ltm-dl-OrJointTCI-StateToAddModList-r18 field in an LTM-TCI-Info information element, the LTM downlink or joint TCI states to release field may correspond to an ltm-dl-OrJointTCI-StateToReleaseList-r18 field in the LTM-TCI-Info information element, the LTM uplink TCI states to add field may correspond to an ltm-ul-TCI-ToAddModList-r18 field in the LTM-TCI-Info information element, the LTM uplink TCI states to release field may correspond to an ltm-ul-TCI-ToReleaseList-r18 field in the LTM-TCI-Info information element, the LTM downlink TCI states to add field may correspond to an ltm-dl-TCI-ToAddModList-r18 field of the LTM-TCI-Info information element, and the LTM downlink TCI states to release field may correspond to an ltm-dl-TCI-ToReleaseList-r18 of the LTM-TCI-Info information element.

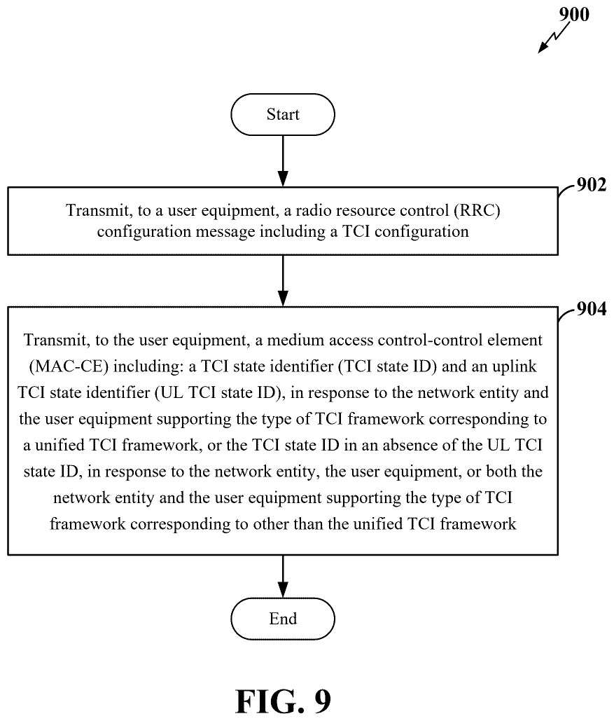

FIG. 9 is a flow chart illustrating an example process 900 (e.g., a method) of wireless communication at a network entity (e.g., an apparatus, an aggregated or disaggregated base station, a gNB, an eNB, a TRP, a scheduling entity, etc.) in accordance with some aspects of the disclosure. As described below, some or all illustrated features may be omitted in a particular implementation within the scope of the present disclosure, and some illustrated features may not be required for implementation of all embodiments. In some examples, the process 900 may be carried out by the network entity 700, as shown and described in connection with FIG. 7. The network entity 700 may be similar to, for example, any of the network entities or scheduling entities of FIGS. 1, 2, 3, 5, 6, and/or 7. In some examples, the process 900 may be carried out by any suitable apparatus or means for carrying out the functions or algorithm described below.

At block 902, the network entity may transmit a radio resource control (RRC) configuration message to a user equipment, including a TCI configuration. Block 902 is similar to block 804 as shown and described in connection with FIG. 8. The detailed description of block 804 is applicable to the transmitting, to the user equipment, the radio resource control (RRC) configuration message including a TCI configuration at block 902. To avoid redundancy, the detailed description of the transmitting, to the user equipment, the radio resource control (RRC) configuration message including a TCI configuration, will not be repeated. Similar to block 804, the RRC configuration circuitry 743, in combination with the transceiver 710 and antenna array(s) 721, for example, may provide a means for transmitting, to the user equipment, a radio resource control (RRC) configuration message including a TCI configuration in connection with block 902.

At block 904, the network entity may transmit, to the user equipment, a medium access control-control element (MAC-CE), including: a TCI state identifier (TCI state ID) and an uplink TCI state identifier (UL TCI state ID), in response to the network entity and the user equipment supporting the type of TCI framework corresponding to a Unified TCI framework, or the TCI state ID in an absence of the UL TCI state ID, in response to the network entity, the user equipment, or both the network entity and the user equipment supporting the type of TCI framework corresponding to other than the Unified TCI framework. For example, the MAC-CE configuration circuitry 744, as shown and described in connection with FIG. 7, may provide a means for transmitting, to the user equipment, a medium access control-control element (MAC-CE) including: a TCI state identifier (TCI state ID) and an uplink TCI state identifier (UL TCI state ID), in response to the network entity and the user equipment supporting the type of TCI framework corresponding to a Unified TCI framework, or the TCI state ID in an absence of the UL TCI state ID, in response to the network entity, the user equipment, or both the network entity and the user equipment supporting the type of TCI framework corresponding to other than the Unified TCI framework.

In accordance with various aspects of the disclosure, an element, any portion of an element, or any combination of elements may be implemented with a processing system 714 that includes one or more processors, generally represented by processor 704. The one or more processors, as utilized in the network entity 700, may be configured to, individually or collectively, based at least in part on information stored in the one or more memories, generally represented by the memory 705 and additionally or alternatively generally represented by the computer-readable medium 706, implement any one or more of the methods or processes described herein and illustrated, for example, in FIGS. 1, 2, 3, 5, 6, 8, and/or 9.

Of course, in the above examples, the circuitry included in the processor 704 of FIG. 7 is merely provided as an example. Other means for carrying out the described processes or functions may be included within various aspects of the present disclosure, including but not limited to the instructions stored in the computer-readable medium 706 of FIG. 7 or any other suitable apparatus or means described in any one of the FIGS. 1, 2, 3, 5, 6, and/or 7 utilizing, for example, the processes and/or algorithms described herein in relation to FIGS. 6, 8, and/or 9.

The following provides an overview of aspects of the present disclosure:

Aspect 1: A method at a network entity, comprising: receiving, from a user equipment, a message indicative of a type of transmission configuration indication (TCI) framework supported by the user equipment; and transmitting, to the user equipment, a radio resource control (RRC) configuration message, including one of one or more TCI configurations corresponding to one of one or more types of TCI frameworks supported by the network entity and supported by the user equipment as indicated in the message received from the user equipment.

Aspect 2: The method of aspect 1, further comprising: transmitting, to the user equipment, the RRC configuration message including a Unified TCI configuration, in response to the network entity and the user equipment supporting the type of TCI framework corresponding to a Unified TCI framework.

Aspect 3: The method of aspect 1 or 2, wherein the Unified TCI configuration includes a first list of downlink TCI states and joint TCI states, and a second list of uplink TCI states.

Aspect 4: The method of any of aspects 1 through 3, further comprising: transmitting, to the user equipment, the RRC configuration message including a Release 15 TCI configuration, in response to at least one of the network entity or the user equipment supporting the type of TCI framework corresponding to other than a Unified TCI framework.

Aspect 5: The method of aspect 4, wherein the Release 15 TCI configuration includes a list of downlink TCI states.

Aspect 6: The method of any of aspects 1 through 5, further comprising: receiving, at the network entity, the message indicative of the type of TCI framework in response to transmitting, to the user equipment, a user equipment capability enquiry message.

Aspect 7: The method of any of aspects 1 through 6, wherein the message indicative of the type of TCI framework is a user equipment capability information (UECapabilityInformation) message.

Aspect 8: The method of any of aspects 1 through 7, wherein the RRC configuration message includes a lower layer triggered mobility (LTM) candidate to add modification list information element indicative of the type of TCI framework.

Aspect 9: The method of aspect 8, wherein the LTM candidate to add modification list information element is configured as one pair of three pairs of fields corresponding to: a first pair of fields indicative of LTM downlink and joint TCI states to add and LTM downlink or joint TCI states to release, a second pair of fields indicative of LTM uplink TCI states to add and LTM uplink TCI states to release, and a third pair of fields indicative of LTM downlink TCI states to add and LTM downlink TCI states to release.

Aspect 10: The method of aspect 9, wherein: the LTM downlink and joint TCI states to add field corresponds to an ltm-dl-OrJointTCI-StateToAddModList-r18 field in an LTM-TCI-Info information element, the LTM downlink or joint TCI states to release field corresponds to an ltm-dl-OrJointTCI-StateToReleaseList-r18 field in the LTM-TCI-Info information element, the LTM uplink TCI states to add field corresponds to an ltm-ul-TCI-ToAddModList-r18 field in the LTM-TCI-Info information element, the LTM uplink TCI states to release field corresponds to an ltm-ul-TCI-ToReleaseList-r18 field in the LTM-TCI-Info information element, the LTM downlink TCI states to add field corresponds to an ltm-dl-TCI-ToAddModList-r18 field of the LTM-TCI-Info information element, and the LTM downlink TCI states to release field corresponds to an ltm-dl-TCI-ToReleaseList-r18 of the LTM-TCI-Info information element.

Aspect 11: The method of any of aspects 1 through 10, further comprising: transmitting, to the user equipment, a medium access control-control element (MAC-CE) including: a TCI state identifier (TCI state ID) and an uplink TCI state identifier (UL TCI state ID), in response to the network entity and the user equipment supporting the type of TCI framework corresponding to a Unified TCI framework; or the TCI state ID in an absence of the UL TCI state ID, in response to the network entity, the user equipment, or both the network entity and the user equipment supporting the type of TCI framework corresponding to other than the Unified TCI framework.

Aspect 12: The method of any of aspects 1 through 11, wherein the message is a user equipment features list, and the user equipment features list includes one of a first feature corresponding to LTM beam indication with joint downlink and uplink TCI states indicative of an optional Unified TCI framework, or a second feature corresponding to LTM beam indication with DL TCI states indicative of a Release 15 TCI framework.

Aspect 13: A network entity, comprising: one or more memories; and one or more processors being configured to, individually or collectively, based at least in part on information stored in the one or more memories: receive, from a user equipment, a message indicative of a type of transmission configuration indication (TCI) framework supported by the user equipment; and transmit, to the user equipment, a radio resource control (RRC) configuration message, including one of one or more TCI configurations corresponding to one of one or more types of TCI frameworks supported by the network entity and supported by the user equipment as indicated in the message received from the user equipment.

Aspect 14: The network entity of aspect 13, wherein the one or more processors are further configured to: transmit, to the user equipment, the RRC configuration message including a Unified TCI configuration, in response to the network entity and the user equipment supporting the type of TCI framework corresponding to a Unified TCI framework.

Aspect 15: The network entity of aspect 14, wherein the Unified TCI configuration includes a first list of downlink TCI states and joint TCI states, and a second list of uplink TCI states.

Aspect 16: The network entity of any of aspects 13 through 15, wherein the one or more processors are further configured to: transmit, to the user equipment, the RRC configuration message including a Release 15 TCI configuration, in response to at least one of the network entity or the user equipment supporting the type of TCI framework corresponding to other than a Unified TCI framework.

Aspect 17: The network entity of aspect 16, wherein the Release 15 TCI configuration includes a list of downlink TCI states.

Aspect 18: The network entity of any of aspects 13 through 17, wherein the one or more processors are further configured to: receive, at the network entity, the message indicative of the type of TCI framework in response to transmitting, to the user equipment, a user equipment capability enquiry message.

Aspect 19: The network entity of any of aspects 13 through 18, wherein the RRC configuration message includes a lower layer triggered mobility (LTM) candidate to add modification list information element indicative of the type of TCI framework.

Aspect 20: The network entity of any of aspects 13 through 19, wherein the one or more processors are further configured to: transmit, to the user equipment, a medium access control-control element (MAC-CE) including: a TCI state identifier (TCI state ID) and an uplink TCI state identifier (UL TCI state ID), in response to the network entity and the user equipment supporting the type of TCI framework corresponding to a Unified TCI framework; or the TCI state ID in an absence of the UL TCI state ID, in response to the network entity, the user equipment, or both the network entity and the user equipment supporting the type of TCI framework corresponding to other than the Unified TCI framework.

Aspect 21: An apparatus configured for wireless communication comprising at least one means for performing a method of any one of aspects 1 through 12.

Aspect 22: A non-transitory computer-readable medium storing computer-executable code, comprising code for causing an apparatus to perform a method of any one of aspects 1 through 12.

Several aspects of a wireless communication network have been presented with reference to an exemplary implementation. As those skilled in the art will readily appreciate, various aspects described throughout this disclosure may be extended to other telecommunication systems, network architectures, and communication standards.

By way of example, various aspects may be implemented within other systems defined by 3GPP, such as Long Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-9 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-9 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing, and other similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Similarly, a phrase referring to A and/or B may include A only, B only, or a combination of A and B.

As used herein, “based on” is intended to be interpreted in the inclusive sense, unless otherwise explicitly indicated. For example, “based on” may be used interchangeably with “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method at a network entity, comprising:
receiving, from a user equipment, a message indicative of a type of transmission configuration indication (TCI) framework supported by the user equipment; and
transmitting, to the user equipment, a radio resource control (RRC) configuration message, including one of one or more TCI configurations corresponding to one of one or more types of TCI frameworks supported by the network entity and supported by the user equipment as indicated in the message received from the user equipment.

2. The method of claim 1, further comprising:
transmitting, to the user equipment, the RRC configuration message including a Unified TCI configuration, in response to the network entity and the user equipment supporting the type of TCI framework corresponding to a Unified TCI framework.

3. The method of claim 2, wherein the Unified TCI configuration includes a first list of downlink TCI states and joint TCI states, and a second list of uplink TCI states.

4. The method of claim 1, further comprising:
transmitting, to the user equipment, the RRC configuration message including a Release 15 TCI configuration, in response to at least one of the network entity or the user equipment supporting the type of TCI framework corresponding to other than a Unified TCI framework.

5. The method of claim 4, wherein the Release 15 TCI configuration includes a list of downlink TCI states.

6. The method of claim 1, further comprising:
receiving, at the network entity, the message indicative of the type of TCI framework in response to transmitting, to the user equipment, a user equipment capability enquiry message.

7. The method of claim 1, wherein the message indicative of the type of TCI framework is a user equipment capability information (UECapabilityInformation) message.

8. The method of claim 1, wherein the RRC configuration message includes a lower layer triggered mobility (LTM) candidate to add modification list information element indicative of the type of TCI framework.

9. The method of claim 8, wherein the LTM candidate to add modification list information element is configured as one pair of three pairs of fields corresponding to:
a first pair of fields indicative of LTM downlink and joint TCI states to add and LTM downlink or joint TCI states to release,
a second pair of fields indicative of LTM uplink TCI states to add and LTM uplink TCI states to release, and
a third pair of fields indicative of LTM downlink TCI states to add and LTM downlink TCI states to release.

10. The method of claim 9, wherein:
the LTM downlink and joint TCI states to add field corresponds to an ltm-dl-OrJointTCI-StateToAddModList-r18 field in an LTM-TCI-Info information element,
the LTM downlink or joint TCI states to release field corresponds to an ltm-dl-OrJointTCI-StateToReleaseList-r18 field in the LTM-TCI-Info information element,
the LTM uplink TCI states to add field corresponds to an ltm-ul-TCI-ToAddModList-r18 field in the LTM-TCI-Info information element,
the LTM uplink TCI states to release field corresponds to an ltm-ul-TCI-ToReleaseList-r18 field in the LTM-TCI-Info information element,
the LTM downlink TCI states to add field corresponds to an ltm-dl-TCI-ToAddModList-r18 field of the LTM-TCI-Info information element, and
the LTM downlink TCI states to release field corresponds to an ltm-dl-TCI-ToReleaseList-r18 of the LTM-TCI-Info information element.

11. The method of claim 1, further comprising:
transmitting, to the user equipment, a medium access control-control element (MAC-CE) including:
a TCI state identifier (TCI state ID) and an uplink TCI state identifier (UL TCI state ID), in response to the network entity and the user equipment supporting the type of TCI framework corresponding to a Unified TCI framework; or
the TCI state ID in an absence of the UL TCI state ID, in response to the network entity, the user equipment, or both the network entity and the user equipment supporting the type of TCI framework corresponding to other than the Unified TCI framework.

12. The method of claim 1, wherein the message is a user equipment features list, and the user equipment features list includes one of a first feature corresponding to LTM beam indication with joint downlink and uplink TCI states indicative of an optional Unified TCI framework, or a second feature corresponding to LTM beam indication with DL TCI states indicative of a Release 15 TCI framework.

13. A network entity, comprising:
one or more memories; and
one or more processors being configured to, individually or collectively, based at least in part on information stored in the one or more memories:
receive, from a user equipment, a message indicative of a type of transmission configuration indication (TCI) framework supported by the user equipment; and
transmit, to the user equipment, a radio resource control (RRC) configuration message, including one of one or more TCI configurations corresponding to one of one or more types of TCI frameworks supported by the network entity and supported by the user equipment as indicated in the message received from the user equipment.

14. The network entity of claim 13, wherein the one or more processors are further configured to:
transmit, to the user equipment, the RRC configuration message including a Unified TCI configuration, in response to the network entity and the user equipment supporting the type of TCI framework corresponding to a Unified TCI framework.

15. The network entity of claim 14, wherein the Unified TCI configuration includes a first list of downlink TCI states and joint TCI states, and a second list of uplink TCI states.

16. The network entity of claim 13, wherein the one or more processors are further configured to:
transmit, to the user equipment, the RRC configuration message including a Release 15 TCI configuration, in response to at least one of the network entity or the user equipment supporting the type of TCI framework corresponding to other than a Unified TCI framework.

17. The network entity of claim 16, wherein the Release 15 TCI configuration includes a list of downlink TCI states.

18. The network entity of claim 13, wherein the one or more processors are further configured to:
receive, at the network entity, the message indicative of the type of TCI framework in response to transmitting, to the user equipment, a user equipment capability enquiry message.

19. The network entity of claim 13, wherein the RRC configuration message includes a lower layer triggered mobility (LTM) candidate to add modification list information element indicative of the type of TCI framework.

20. The network entity of claim 13, wherein the one or more processors are further configured to:
transmit, to the user equipment, a medium access control-control element (MAC-CE) including:
a TCI state identifier (TCI state ID) and an uplink TCI state identifier (UL TCI state ID), in response to the network entity and the user equipment supporting the type of TCI framework corresponding to a Unified TCI framework; or
the TCI state ID in an absence of the UL TCI state ID, in response to the network entity, the user equipment, or both the network entity and the user equipment supporting the type of TCI framework corresponding to other than the Unified TCI framework.
